(19) United States
(12) Patent Application Publication
(10) Pub. No.: US 2024/0152737 A1
(43) Pub. Date: May 9, 2024

(54) METHOD AND ARCHITECTURE FOR ABSOLUTE AVERAGE DEVIATION POOLING FOR CONVOLUTIONAL NEURAL NETWORK ACCELERATORS

(71) Applicant: UNIVERSITY OF LOUISIAN LAFAYETTE, Lafayette, LA (US)

(72) Inventors: Kasem KHALIL, Lafayette, LA (US); Omar Eldash, Lafayette, LA (US); Ashtok Kumar, Lafayette, LA (US); Magdy Bayoumi, Lafayette, LA (US)

(73) Assignee: UNIVERSITY OF LOUISIANA LAFAYETTE, lafayette, LA (US)

(21) Appl. No.: 18/383,454

(22) Filed: Oct. 24, 2023

Related U.S. Application Data
(60) Provisional application No. 63/419,762, filed on Oct. 27, 2022.

(51) Int. Cl. G06N 3/0464

(52) U.S. Cl. CPC G06N 3/0464

(57) ABSTRACT

Disclosed herein is a method and device for absolute average deviation (AAD) pooling for a convolutional neural network accelerator. AAD utilizes the spatial locality of pixels using vertical and horizontal deviations to achieve higher accuracy, lower area, and lower power consumption than mixed pooling without increasing the computational complexity. AAD achieves 98% accuracy with lower computational and hardware costs compared to mixed pooling, making it an ideal pooling mechanism for an IoT CNN accelerator.

### CROSS REFERENCE TO RELATED APPLICATIONS

This application claims priority to U.S. Provisional Application No. 63/419,762 titled “ABSOLUTE AVERAGE DEVIATION POOLING METHOD IN HARDWARE FOR CONVOLUTIONAL NEURAL NETWORK ACCELERATOR”, filed on Oct. 27, 2022.

### STATEMENT REGARDING FEDERALLY SPONSORED RESEARCH OR DEVELOPMENT

Not applicable.

### REFERENCE TO A “SEQUENCE LISTING,” A TABLE, OR A COMPUTER PROGRAM

Not applicable.

### FIELD OF THE INVENTION

The present invention relates to the field of neural network computing systems, specifically the use of absolute average deviation pooling in convolutional neural networks, implemented through hardware.

### DESCRIPTION OF THE DRAWINGS

The drawings constitute a part of this specification and include exemplary embodiments of the ABSOLUTE AVERAGE DEVIATION POOLING METHOD IN HARDWARE FOR CONVOLUTIONAL NEURAL NETWORK ACCELERATORS, which may be embodied in various forms. It is to be understood that in some instances, various aspects of the invention may be shown exaggerated or enlarged to facilitate an understanding of the invention. Therefore, the drawings may not be to scale. For purposes of clarity, not every component may be labeled in every drawing.

FIG. 1 is a model of a typical convolutional neural network (CNN) architecture known in the art. The CNN architecture consisting of five main input layers: input; convolution; pooling; fully connected; and output.

FIG. 2 is a model of the absolute average deviation (AAD) pooling stage in a CNN.

FIG. 3A is an example resulting feature map after applying AAD pooling with a 2×2 filter with horizontal deviation.

FIG. 3B is an example resulting feature map after applying AAD pooling with a 2×2 filter with vertical deviation.

FIG. 3C is an example resulting feature map after applying AAD pooling with a 3×3 filter with horizontal deviation.

FIG. 3D is an example resulting feature map after applying AAD pooling with a 3×3 filter with vertical deviation.

FIG. 4A is an example resulting feature map after applying AAD pooling with a 2×2 filter and a stride of 1 with horizontal deviation.

FIG. 4B is an example resulting feature map after applying AAD pooling with a 3×3 filter and a stride of 1 with vertical deviation.

FIG. 5A is the input data used in an example of AAD pooling with a stride of 2.

FIG. 5B is the resulting feature map from using AAD pooling with a stride of 2 using horizontal deviation of the data in FIG. 5(a).

FIG. 5C is the resulting feature map from using AAD pooling with a stride of 2 using vertical deviation of the data in FIG. 5(a).

FIG. 5D is the resulting feature map from using AAD pooling with a stride of 2 using both horizontal and vertical deviation of the data in FIG. 5(a).

FIG. 6A is the results of the AAD max pooling process using a feature map.

FIG. 6B is the results of the max pooling process from FIG. 6(a) expressed in digits.

FIG. 7A is the results of the AAD average pooling process using a feature map.

FIG. 7B is the results of the average pooling process from FIG. 7(a) expressed in digits.

FIG. 8 is the hardware architecture for AAD with two inputs X1 and X2.

FIG. 9 is the hardware architecture for AAD based on parallel computation.

FIG. 10 show the process of computation for multiple values carried out in parallel.

FIG. 11 is the hardware AAD architecture using a sliding window.

FIG. 12 is a chart of the Gaussian distributions of AAD versus mixed, average, and max pooling.

FIG. 13 is a chart of the separability versus cardinality for AAD versus mixed, average, and max pooling with α₁=0.4 and α₂=0.2.

FIG. 14 is a bar graph showing the separability performance with different values of α₁ and α₂ for AAD, mixed, average, and max pooling.

FIG. 15 is a table showing the results of comparison between the disclosed AAD pooling method and other methods in complete CNN implementations.

FIG. 16 is a table showing the results of an accuracy comparison of different neural networks architectures using the USPS dataset.

FIG. 17 is a table showing the hardware resource utilization for AAD, max, average, mixed, and LBP pooling methods in AlexNet structure using the USPS dataset.

FIG. 18 is a table showing the hardware performance comparison between AAD and the other pooling for accelerators.

FIG. 19 is a bar graph showing the hardware results of separability for AAD, mixed, average, and max pooling using the USPS dataset.

### BACKGROUND OF THE INVENTION

Advancements in machine learning expanded its use to multiple domains. Such domains include but are not limited to object tracking, text detection, text recognition, image classification, cancer prognosis prediction, prediction of disease in ductal carcinoma, nutrition monitoring, treatment assistance, disease detection, hardware fault prediction, and action recognition. In deep learning, layered structures—such as deep neural network, recurrent neural network, and convolutional neural network (CNN)—are commonly used to handle large-scaled and unstructured data. The advantage of CNNs is reducing the number of parameters in the artificial neural network (ANN). This benefit has allowed both users and researchers to solve very complex problems, which could not be solved efficiently with classic ANNs. Hardware implementations of CNNs, known as hardware accelerator or CNN accelerator, are expected to provide as high accuracy as possible while consuming a reasonable amount of power and on-chip area. Higher accuracy of pooling, and by extension higher accuracy of CNN accelerator, is useful for the Internet of Things (IoT)-based applications involving security, medical and healthcare, and face recognition.

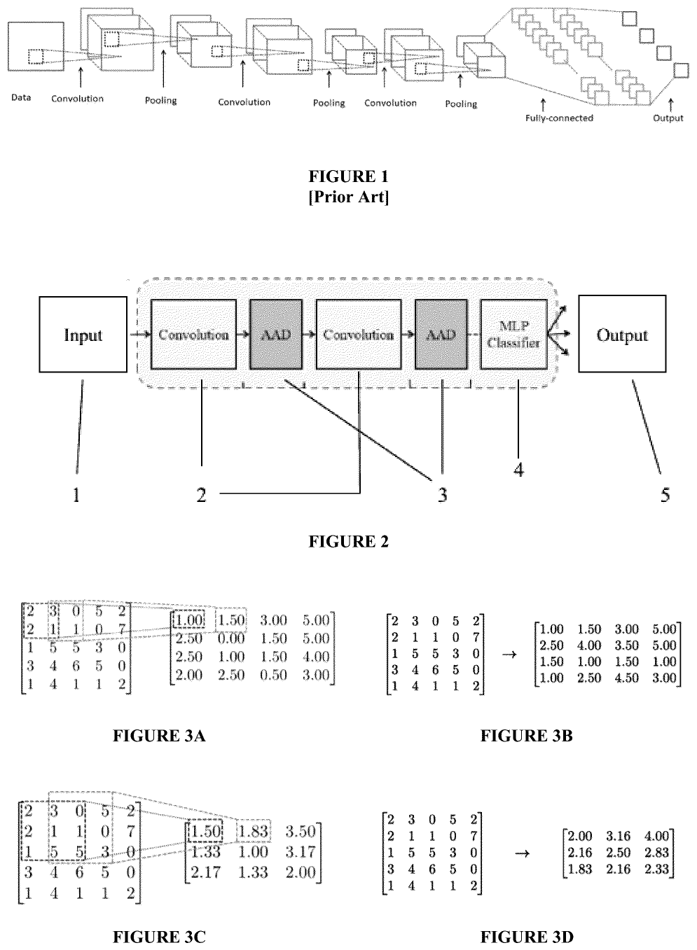

Typical CNN uses three types of layers: convolutional layer, pooling layer, and a fully connected layer, as shown in FIG. 1. The convolutional layer comprises weights and connections of shared characteristics, and it aims to learn the feature representations of the inputs. The convolutional layer consists of several feature maps (i.e., intermediate representation of data). For a new feature, the input feature map is applied for convolution with a learning kernel, and then, the outputs are passed into a nonlinear activation function such as tanh, rectified linear unit (ReLU), and sigmoid. For example, the ReLU function adds nonlinearity, provides robustness against noise, and is given by the following equation:

$${f}_{ReLU} ( y ) = \{ \begin{matrix}y , & if y \geq 0 \\ 0 , & if y \leq 0.\end{matrix} \qquad ( 1 )$$

In Equation 1 above, y is an input to the ReLU function. The dimension of the convolution's result is lower than the input dimension if no padding is used. The output dimension depends on the filter size and stride, and the output size is given by the following equation:

$${Out}_{size} = \frac{M - F + 2 P}{S} + 1. \qquad ( 2 )$$

In the above Equation 2, M is the input size, F is the filter size, S is the stride size, and P is the padding size.

The second part of CNN is the pooling layer, which is used for spatial invariance by reducing the resulting feature maps' resolution. The resulting feature map's size after pooling is determined according to the kernels' moving step as given by Equation 2. The last layer of CNN is the fully connected layer, also called multilayer perceptron (MLP), and it consists of layers such that each layer has many neurons (nodes). Each node in a layer is directly connected to nodes in both the previous and the subsequent layers. The fully connected layer is connected to the last output node for classification results. A function such as softmax can be used at this stage for classification. The softmax function calculates the probabilities of classes, and is given by the following equation:

$${f}_{c} ( {x}_{j} ) = \frac{{e}^{{x}_{j}}}{{\sum }_{j}^{i} {e}^{{x}_{j}}} for j = 1 , 2 , 3 , … , k . \qquad ( 3 )$$

In Equation 3 above, x is the input signal and k is the number of output classes.

Hardware implementation of pooling is a good indicator of the feasibility and cost of on-chip design, and without hardware implementation, pooling can become a bottleneck of the entire system. Average pooling is suitable for hardware implementation, and it considers the average of the non-pooled data. It is based on all elements in the pooling region, and it attains high performance by reducing the error of estimate variance. It is used in applications such as predicting cerebral microbleeds. It also retains background information in image processing. The disadvantage of the average pooling is that it fails to account for many zero elements. Consequently, the resulting features after the average pooling process do not preserve high accuracy.

Max pooling uses the maximum value of the non-pooled data, and it is suitable for hardware implementation. It attains higher accuracy than the average pooling by decreasing the offset errors of assessed values from the convolutional layer, and it saves more texture information. The max pooling's disadvantage is that the smaller values of activation are ignored, limiting its accuracy. After max pooling, the resulting features are large, and generating overfitting is easy. However, the full generalization capability of the resulting network is weak. Max pooling has been implemented in hardware prior art.

Mixed pooling uses both average and max pooling methods, and it is suitable for hardware implementation. Mixed pooling stochastically determines pooling operation by randomly selecting either max or average pooling. It attains higher precision than both the average and max methods. The mixed pooling's challenge is due to the complexity of switching between max pooling and average pooling, and its accuracy is bounded by that of the max and average pooling. The local binary pooling (LBP) is used by sequentially comparing neighboring pixels' intensity to a central pixel within a patch. Neighbors with a higher intensity value than the central pixel are assigned the value of “1,” whereas the other pixels are assigned the value of “0”. LBP attains a lower accuracy than mixed pooling.

Stochastic pooling uses multinomial distribution to choose values randomly. In each data region, some probabilities are computed by normalizing the activations in the region. These probabilities are used to create a multidimensional distribution that determines the selected location and corresponding pooled activation. It attains a lower accuracy than the mixed pooling, and it is not a candidate for CNN accelerators targeting high precision. Another pooling method, called random pooling, is based on randomly selecting an activation value. It can minimize overfitting by randomness while preserving the characteristics of the original value. Random pooling, however, results in poor precision for classifications, and it is not a candidate for CNN accelerators. Multipartite pooling uses learning to choose the most informative representations.

Instead of maximum, average, or random selection, it chooses the highest scored features. It achieves a lower accuracy than mixed pooling. Matrix 2-norm pooling uses energy information hidden in the input image. It attains a lower accuracy than the mixed pooling, and it is not a candidate for CNN accelerators.

### SUMMARY OF THE INVENTION

Disclosed herein is an absolute average deviation (AAD) pooling method for CNN accelerator observes and utilizes deviations between pixels to capture highly accurate representation. In integrated implementations, AAD attains a higher classification accuracy than the other pooling methods used in the CNN accelerator by using the deviation between pixels. Also, excellent separabilities are achieved in hardware implementation, signifying attainment of very high precision.

Further disclosed is the architecture to implement the pooling method, comprising at least two convolutional layers, at least two AAD pooling layers, and a multi-layer perceptron classifier. The disclosed AAD pooling layer implements three stages: a subtraction stage, an absolute state, and a division stage. In one specific embodiment, the architecture further comprises a sliding window, wherein the window size depends on the size of the pooling.

### DETAILED DESCRIPTION OF THE INVENTION

The placement of the AAD pooling layer in a CNN is shown in FIG. 2. In one or more embodiments, the input data 1 can be fed into the first convolution layer 2, and then, the output can pass to the AAD pooling layer 3. The output of the pooling layer 3 can pass to the second convolution layer 2. This sequence can be repeated all the way through the fully connected layer and a multi-layer perceptron classifier 4 for classification, and then, it provides the output results 5. FIG. 2 shows one embodiment of the hardware for AAD pooling, but those having skill in the art will recognize other suitable configurations and additional elements that can be incorporated. AAD pooling can reduce the complexity by measuring the deviation between the neighboring pixels and then by calculating the average of these deviations. One embodiment of an AAD pooling calculation is by the following:

$$p = \frac{1}{N ( N - 1 )} {\sum }_{i = 1}^{N} {\sum }_{j = 1}^{N - 1} \vert {x}_{i , j} - {x}_{i , j + 1} \vert , \qquad ( 4 )$$

In Equation 4 above, p is the output after AAD pooling, N is the filter size, and x_{i,j} is the single feature map value. One of the most common sizes used in pooling is 2×2. In this case, the general equation (4) can be written as follows:

$$p = \frac{1}{2} {\sum }_{i = 1}^{2} \vert {x}_{i , 1} - {x}_{i , 2} \vert . \qquad ( 5 )$$

The dimension of the image feature map after AAD pooling can be given by Equation 2. For example, the feature map obtained after applying AAD pooling with 2×2 filters and a stride of 1 with horizontal deviation is shown in FIG. 3(A). AAD pooling calculates the average deviation of each of the four pixels in this example. The result's size is 4×4, as calculated from Equation 2. In case of a larger filter size such as 3×3 filters, the dimension of the results using Equation 2 is 3×3, and the result is shown in FIG. 3(C) for the same dataset. For vertical deviation, the AAD pooling can be calculated by the second term of the general equation and can be obtained in the following:

$$p = \frac{1}{N ( N - 1 )} {\sum }_{j = 1}^{N} {\sum }_{i = 1}^{N - 1} \vert {x}_{j , i} - {x}_{j , i + 1} \vert . \qquad ( 6 )$$

For Equation 6 above, I is used for row pointer and j is used for column pointer. Using the same prior example, the output result is given as shown in FIG. 3(B) and (D). For the general AAD pooling, it can be applied to both horizontal and vertical deviations. In this case, the proposed pooling can be the following:

$$p = \frac{1}{2 N ( N - 1 )} [ {\sum }_{i = 1}^{N} {\sum }_{j = 1}^{N - 1} \vert {x}_{i , j} - {x}_{i , j + 1} \vert + {\sum }_{j = 1}^{N} {\sum }_{i = 1}^{N - 1} \vert {x}_{j , i} - {x}_{j , i + 1} \vert ] . \qquad ( 7 )$$

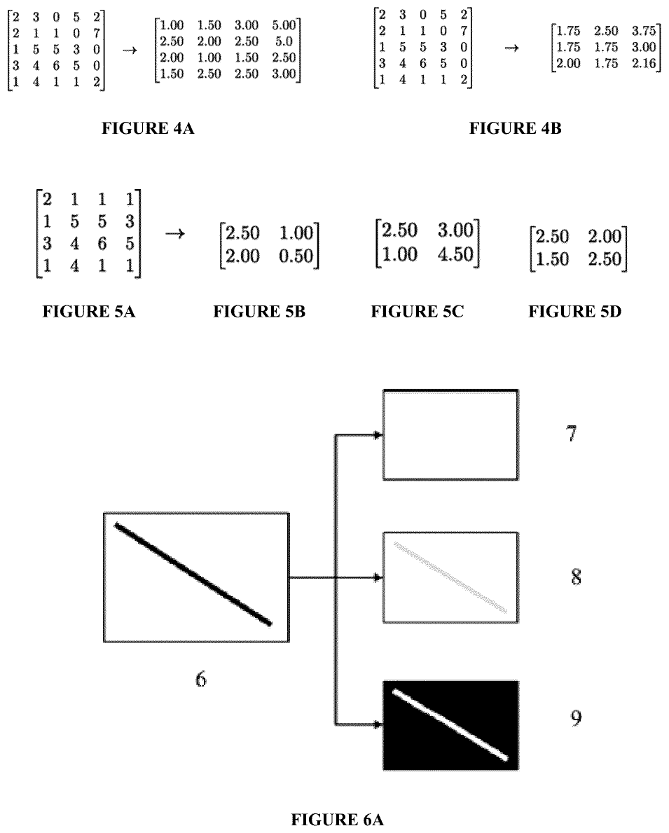

Here, i is used for row pointer and j is used for column pointer. For the same previous example, the result after AAD pooling in both horizontal and vertical directions is shown in FIG. 4. The AAD method with a different stride of two is shown in FIG. 5. It shows the result after horizontal, vertical, and both horizontal and vertical deviations. The disclosed method works with different strides values. Both vertical and horizontal deviations are used for AAD pooling, increasing the networking accuracy by getting the most accurate representation value of the pixels with higher area overhead compared to using either horizontal or vertical deviations. The computational complexity of the proposed AAD pooling method can be Θ(N²) as it has two iterations as shown in Equation 7 above. Max, average, and mixed pooling each have Θ(N²) computational complexity. Thus, the AAD method has the same computational complexity, but provides higher accuracy, making it suitable for use in the CNN accelerator for the IoT applications requiring very high accuracy.

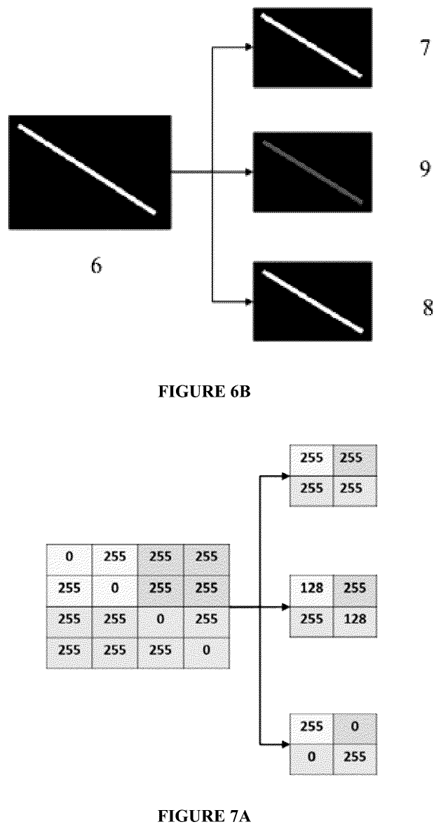

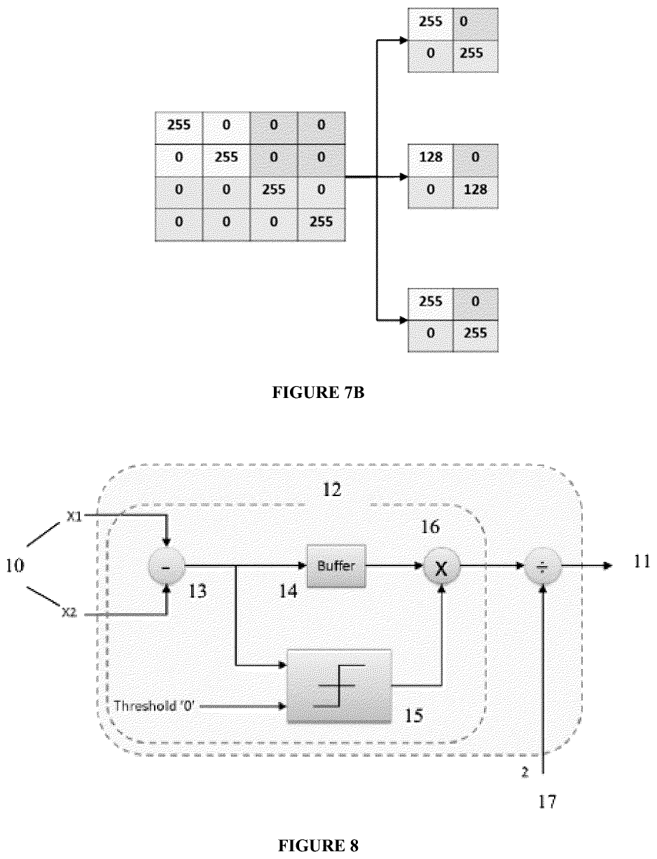

The AAD captures and uses pixel variance better than the max and average pooling methods. For example, to understand the drawback of the max pooling, assume that in one embodiment most of the pooling area elements are of high amplitudes. The max pooling result 7 shows that method loses the distinguishing feature of the input feature map 6, as shown in FIG. 6. The AAD pooling method result 8 shows a clear distinguishing feature that shows it is very effective with opposite colors, as shown in FIG. 6. In another embodiment, assume that most of the pooling area elements are of low amplitudes (zero elements) to understand the drawback of the average pooling method. The average method result 9 indicates that the feature map characteristics are reduced largely using that method, as shown in FIG. 7. On the other hand, the AAD pooling method provides a clear result with keeping the feature map characteristics, as shown in FIG. 7. Mixed pooling uses either max or average for pooling operation, and it provides an increased accuracy than both of them. The AAD pooling method provides higher accuracy than the mixed pooling method.

One embodiment of the hardware architecture for AAD circuit 25 is shown in FIG. 8 comprising two inputs 10. The AAD circuit 25 is divided into three sections: a subtraction stage, an absolute stage, and a division stage.

The two inputs of an embodiment of the AAD circuit 25 are applied to the subtraction operator 13 to get the deviation between them. The output has two routes. Output route one is applied to the comparator circuit 15. The comparator circuit 15 is used to get the absolute value of the subtraction result and output the same sign as the input. The comparator circuit 15 compares its input to a threshold value which is “0.” In one embodiment, if the input to the comparator circuit 15 is positive, the comparator circuit provides a positive one as its output. In a further embodiment, the comparator circuit 15 outputs a negative one if the comparator circuit input is negative. The second branch of the subtraction output is applied to a buffer 14. The buffer 14 can be used to provide synchronization between the comparator circuit output and the buffer output for a multiplication operator 16. The buffer 14 and the comparator circuit 15 outputs can be multiplied to get the absolute deviation. A person having ordinary skill in the art will recognize that absolute deviation can be obtained using other operations. If the subtraction operator 13 result is positive, the comparator output is a positive one, and the multiplication result is positive. In the case the subtraction operator 13 result is negative, the comparator circuit 15 output is a negative one, and the multiplication result is positive. Thus, this stage produces the absolute deviation, and the result then preferably is divided by 2 by the divider circuit 17 to get the final output.

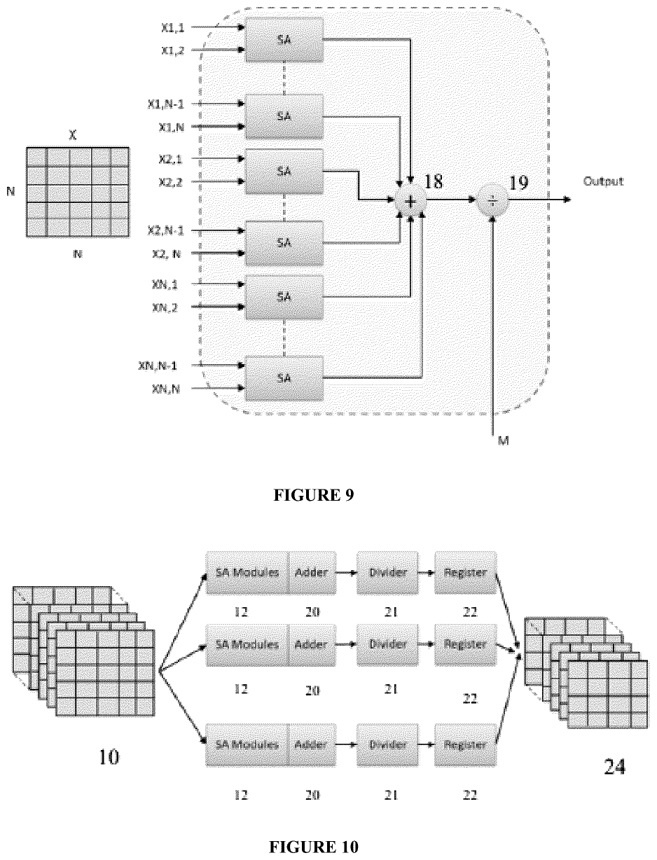

The block diagram of the subtraction absolute (SA) block 12 is shown in FIG. 8. In one embodiment, the AAD process may operate in parallel and the general parallel AAD architecture may comprise multiple SA blocks subtraction operator 13 depending on the number of inputs 10, as shown in FIG. 9. The first stage is the SA block 12, which provides an absolute value of a division between inputs 10. For example, the first SA block 12 provides the absolute value of deviation between inputs of X1,1 and X1,2 (the first and the second value in the first row). Multiple SA blocks are used, and their outputs are applied to a summation circuit 18, and the result is divided by the divider circuit 19 by the M=N(N−1) to provide the final output of the AAD circuit 25. The computation for multiple values is carried out in parallel, as shown in FIG. 10. A feature map is applied to SA blocks 12, and the outputs are summed to get a single output value. This value is divided by the average deviation value, and the final output represents the value of the non-pooled matrix values. This is repeated for each selected region in the feature map. The results are saved in register 22 to represent the resulting feature map, which has a smaller dimension than the non-pooled one. Registers 22 are used for storing the features data for the next stage.

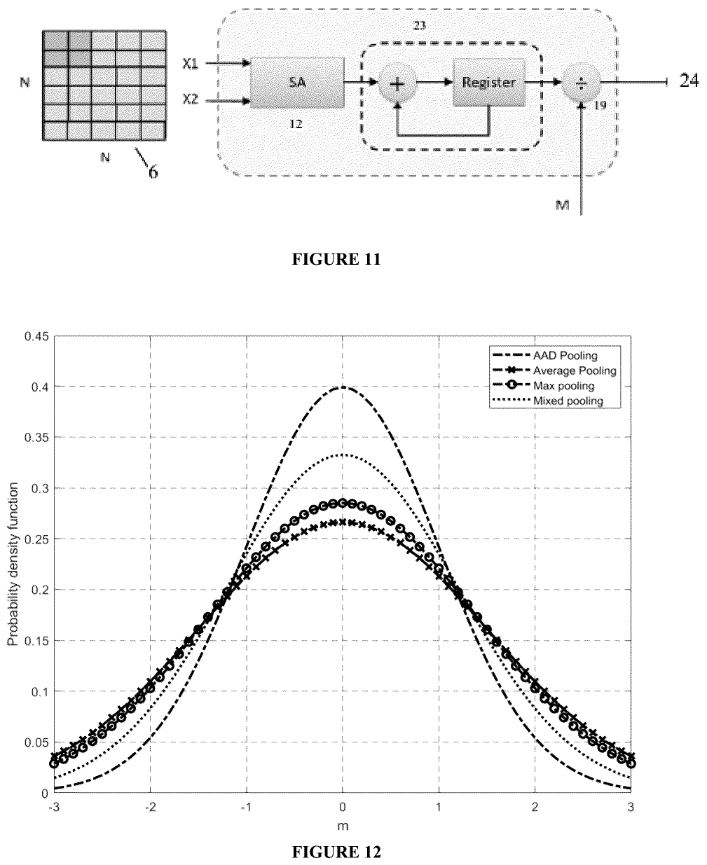

Due to the complexity of the architecture shown in FIG. 9, a further embodiment incorporates a sliding window algorithm. As known by persons of ordinary skill, a sliding window algorithm is an attention mechanism applied in deep learning where a window of size m×n pixels is taken and is traversed through the input image to find the target object(s) in that image. The AAD architecture embodiment incorporating a sliding window is shown in FIG. 11. A sliding window is used over the data, and the window size is determined by the pooling size. The window slides by a distance that is defined by stride, which modifies the amount of movement by the window over the image. The input 10 is applied to the subtraction operator 13 to get the deviation between pixels. A register 22 is used to save the resulted output of the summation circuit 18. Thus, the subtraction operator 13 output is accumulated with the previously saved data in the register 22 to get the final sum of deviation. The accumulator 23 output is divided by M.

Analysis of the AAD pooling method is now provided. The Gaussian distribution is used for the study of AAD and comparing it with other pooling methods. Standard deviation is the accepted method for studying the overall separability of the classes in the literature. Assume that a vector of n-dimension has function values (f(x¹), f(x²), f(x³), f(x⁴), . . . , f(xⁿ)), which are evaluated at xⁱϵχ, where χ is the input space and i=1, 2, 3, . . . n. f is the Gaussian process (GP) if f: χ→

[symbol]

f(x)˜GP(m(x),k(x,x′)). (8)

In Equation 8, m is the mean and k is the covariance. In the case of a finite subset (f(x¹), f(x²), f(x³), f(x⁴), . . . , f(xⁿ)) has a multivariate Gaussian distribution, the GP will be defined over the index set χ equivalent to the input domain. It will be completely fixed by its covariance and mean functions as described through the following:

m(x)= [symbol] (f(x)) (9)

k(x,x′)=cov(f(x),f(x′)) (10)

k(x,x′)= [symbol] ((f(x)−m(x))·f(x′)−m(x′)). (11)

In the case of x, x′ϵχ, the covariance function k: χ×χ→ [symbol] refers to the similarity or nearness between two inputs x and x′. Assume that a sample points of input X=(x¹, x², x³, . . . , xⁿ), the covariance of this sample is given by matrix of K(X, X)ϵ [symbol] ^{n×n} with entries of K_{i,j}=k(xⁱ, x^{j}).

For input data of x={x¹, x², x³,. . . , xⁿ}, and the variation between two successive values (deviations) will be given by {δ₁, δ₂, δ₃, . . . , δₙ₋₁}. These deviations indicate the changing pixels, and the result provides an accurate data representation of the variations. The Gaussian distribution is obtained for the proposed method using the ImageNet dataset. The advantage of the proposed method is that it provides an accurate data representation of the original non-pooling data. The Gaussian distribution of the output feature of the pooling layers is presented in FIG. 12, and the disclosed method is compared with the average, max, and mixed methods used for CNN accelerators. The AAD pooling has better distribution and a smaller standard deviation than the other pooling methods, which increases the accuracy of classification. A smaller standard deviation indicates a higher separability, which in turn indicates increased classification accuracy.

The AAD also reduces the training error. To understand it further, consider two classes in binary features that need to be distinguished from each other. The classification accuracy will be high if there is no overlap between the distribution of the two classes. Separability can be defined as a signal-to-noise ratio issue. The accuracy improves if the separability of the resulting feature distributions increases. The binomial distribution is the accepted method in literature for studying specific separability for a pooling method. Given two classes C₁ and C₂ and the separation of conditional distributions p(f|C₁) and p(f|C₂), the distribution function of f is scaled-down binomial distribution, and it has a mean μ=2α(1−α) and variance

$${σ}^{2} = ( \frac{2 α ( 1 - α ) ( \vert 1 - 2 α ( 1 - α ) \vert )}{N ( N - 1 )} ) ) .$$

The separability of AAD is given by the following:

$${ψ}_{AAD} = \frac{2 \vert {α}_{1} - {α}_{2} \vert \cdot \sqrt{N \cdot ( N - 1 )}}{\sqrt{2 {α}_{1} ( \vert 1 - {α}_{1} \vert )} + \sqrt{2 {α}_{2} ( \vert 1 - {α}_{2} \vert )}} . \qquad ( 12 )$$

In the above, Ψ_{AAD} is the AAD separability and α₁ and α₂ are the means of two different classes. The separability of the max pooling is given by the following:

$${ψ}_{max} = \frac{\vert {( 1 - {α}_{1} )}^{{N}^{2}} - {( 1 - {α}_{2} )}^{{N}^{2}} \vert}{( ( 1 - {( 1 - {α}_{1} )}^{{N}^{2}} ) ( 1 - {( 1 - {α}_{2} )}^{{N}^{2}} ) )} . \qquad ( 13 )$$

The separability of the average pooling is given by the following:

$${ψ}_{average} = \frac{\vert {α}_{1} - {α}_{2} \vert \cdot \sqrt{N}}{( \sqrt{{α}_{1} ( \vert 1 - {α}_{1} \vert )} + \sqrt{{α}_{2} ( \vert 1 - {α}_{2} \vert )} )} . \qquad ( 14 )$$

The separability of the mixed pooling is determined by the following:

ψ_{mixed}=(ψ_{average}²+ψₘₐₓ²)^{0.5}. (15)

The variance of the max pooling is σ²=(1−(1−α)^{N}^{²})(1−α)^{N}^{²}, while the variance of average pooling is

$${σ}^{2} = \frac{α ( \vert 1 - α \vert )}{N} .$$

The AAD method has a lower variance or standard deviation compared to them. This analysis shows that the AAD's separability is higher than the pooling methods known in the art for CNN accelerator, and its accuracy is higher for classification.

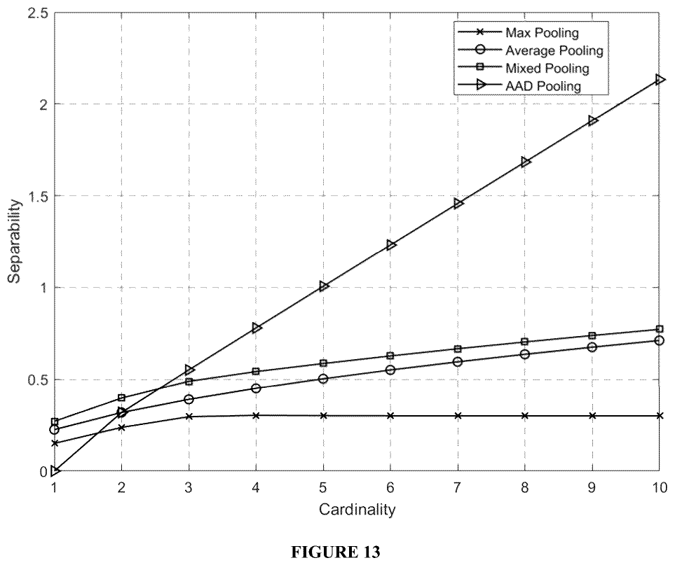

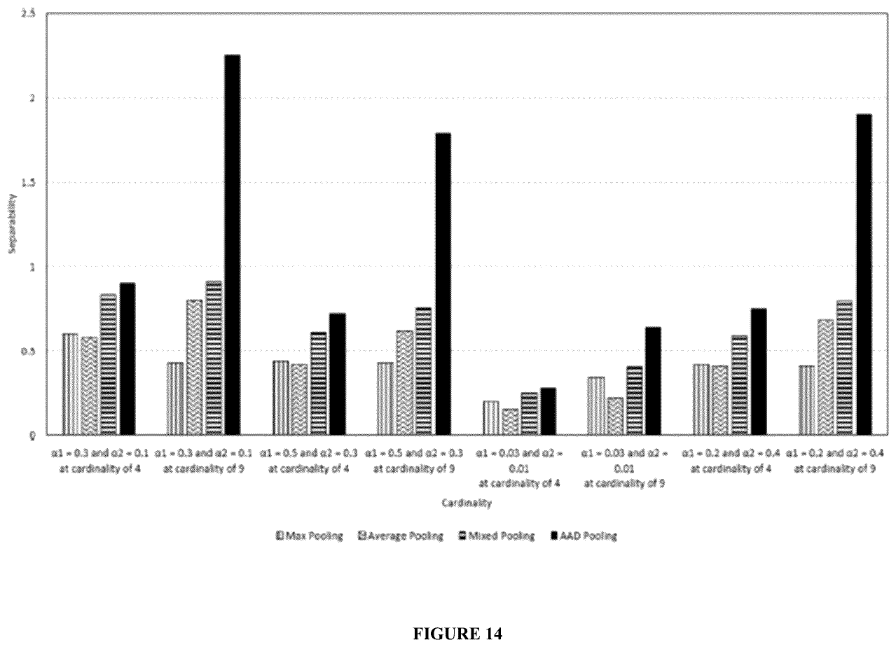

Using the ImageNet dataset, examples can be provided to illustrate the method. For example, the separability is studied with α₁=0.4 and α₂=0.2, and the results show that AAD has a higher separability than the mixed, max, and average pooling methods with different values of cardinality that refers to sets of elements (i.e., the number of pixels in the feature map) as shown in FIG. 13. Separability is also studied with multiple values of α, and the results show that the proposed method is consistent in performance using (α₁=0.5 and α₂=0.3), (α₁=0.3 and α₂=0.1), and (α₁=0.03 and α₂=0.01), as shown in FIG. 14. In the max-pooling method, the maximum value of a window of values is not accurate when the values are small and close to each other. In mixed pooling, the pooling is selected randomly. The AAD method has a lower standard deviation and higher separability than max, average, and mixed methods, resulting in more accurate CNN classification.

Testing of the method and hardware is now detailed. The AAD pooling was implemented in the following network architectures: VGG16, AlexNet, VGG19, ResNet, and DenseNet.

Dataset. The disclosed method was tested using four different data sets. The first dataset is EEG, which is a registration of the brain's electrical activity. It is classified into two types: intracranial EEG and scalp EEG. Intracranial EEG is observed by implanting electrodes in the brain during surgery, while scalp EEG is obtained by attaching electrodes to the scalp. EEG signals are important and significant for the treatment of epileptic seizures. It consists of five subsets, and each subset contains 100 signal channel EEG signals, where each signal has a duration of 23.6 s. These subsets are the following. Subset F is interictal from the epileptogenic subset N is the interictal from the hippocampus region in the brain. Subset Z is healthy with opening eyes, subset 0 is healthy with closed eyes, and subset S is epileptic during an epileptic seizure. The second dataset is ImageCLEF2016, which is used for medical image classification. It consists of 6776 images for training and 4166 images for testing. We have used other different datasets to validate the proposed AAD method. The third dataset is ImageNet. ImageNet includes 3.2 million cleanly labeled full resolution images with 12 subtrees with 5247 synonym sets or synsets. In this dataset, 150 k samples are used for training and 5 k samples are used for testing. The Common Objects in Context (COCO) dataset is also used, and it contains 2500000 labeled instances in 328 000 images. It includes 91 common object categories and 82 of them have more than 5000 labeled instances, and 150 k samples are used for training and 5 k samples are used for testing. The final dataset is the United States Postal Service (USPS) dataset, which is a postal library of American Postal Services and includes 9000 samples for recognition.

Feature Extraction and Classification. The feature extraction is obtained through two operations: convolution and pooling. In the convolution stage, the goal is to learn feature representations of the inputs. The convolutional layer consists of multiple convolutional layers. For the inventors study, a filter size 3×3 was used for the convolution operation. The output size depends on the filter size and stride as given by Equation 2, and the number of convolutional layers is six. Convolutions with stride 1 that moves the filters to 1 pixel at a time was used. The second part is the pooling, which serves as the second feature extractor. It reduces the dimension of the output feature maps through down-sampling. In the proposed architecture, AAD pooling is used, which is determined by Equation 4 or Equation 5 for the filter size of 2×2 with stride 1 for six pooling layers. The convolutional and pooling layers use an activation function to produce the final output. The ReLU activation function was used in the proposed method. The classification stage is realized through fully connected layers. Softmax regression is used for classification tasks in our model.

Training and Testing Method. A cross-validation technique was used for training and testing. After the feature extraction process, the generated records are grouped with their class labels. AAD is trained and tested with the four different datasets. For each full dataset, 60% of the data was selected to be the training set, 20% as the validation set, and 20% for the test. Thus, the dataset has been divided into five training and testing, and these percentages are repeated five times through different combinations to use the entire data. The training is studied with 7000 epochs.

Evaluation Parameters. AAD is implemented in a complete CNN to get evidence of its functionality and accuracy. The integrated, complete CNN implementation of AAD is evaluated using the metrics of true positives (TPs), true negatives (TNs), false positives (FPs), and false negatives (FNs). These metrics assess the accuracy of complete implementation. TP refers to the total number of the correct outcomes within a specific duration. TF is an outcome in which the model incorrectly classifies the uncorrected class. FP is the number of correct outcomes that do not occur, but they are mistakenly counted as occurred outcomes within a specific duration. FN is the total number of incorrect outcomes that occur within a specific duration. The metrics of evaluation are sensitivity, specificity, precision, tension, and accuracy. The evaluation parameters are given by the following Equations 16, 17, 18, 19, and 20.

Sensitivity refers to the ratio between the correct number of identified classes and the total sum of TPs and false negatives:

$$Sensitivity = \frac{TP}{TP + FN} . \qquad ( 16 )$$

Specificity measures the fraction of actual negatives that are correctly identified:

$$Specificity = \frac{TN}{TN + FP} . \qquad ( 17 )$$

Precision is the ratio between the correct number of identified classes and the sum of

the correct and incorrect classes:

$$Precision = \frac{TP}{TP + FP} . \qquad ( 18 )$$

Tension is the relation between sensitivity and precision, which should be balanced. Increasing precision results in a decreasing sensitivity, so there is a tradeoff between the values. The sensitivity improves with low false negatives, which results in increasing false positives, and it reduces precision.

$$Tension = \frac{2 * Sensitivity * Precision}{Sensitivity + Precision} . \qquad ( 19 )$$

Accuracy refers to the test's ability to differentiate classes correctly:

$$Accuracy = \frac{TP + TN}{TP + TN + FP + FN} . \qquad ( 20 )$$

Hardware Implementation. The hardware implementation of AAD consists of multiple SA modules to provide the absolute value of the subtraction between inputs. The SA module is the main unit in the AAD pooling method. The outputs from the SA modules are summed to get the total deviation value, and the result is divided by M, as shown in FIG. 11. After computations of the convolutional layer, multiple feature maps are created depending on used filters. It is observed that when pooling computations are done in parallel, as shown in FIG. 10, it results in a larger area and power consumption. Therefore, pooling is performed using a sliding window method, as shown in FIG. 11. The sliding method saves 78% and 72% of area and power consumption, respectively, compared to the parallel method. The proposed sliding method is implemented and tested using the USPS dataset on hardware for validation. The AAD method provides an accurate data representation and attains an increased classification accuracy. For example, in the case of using AlexNet structure and USPS dataset, the sliding method achieves an accuracy of 98.51%, whereas average- and max-pooling methods achieve an accuracy of 96.86% and 96.39%, respectively. All hardware modules are implemented using Very High Speed Integrated Circuit (VHSIC) Hardware Description Language (VHDL) and tested on Altera Arria 10 GX FPGA. The AAD pooling is also implemented using Synopsys® Design Compiler in 45-nm technology.

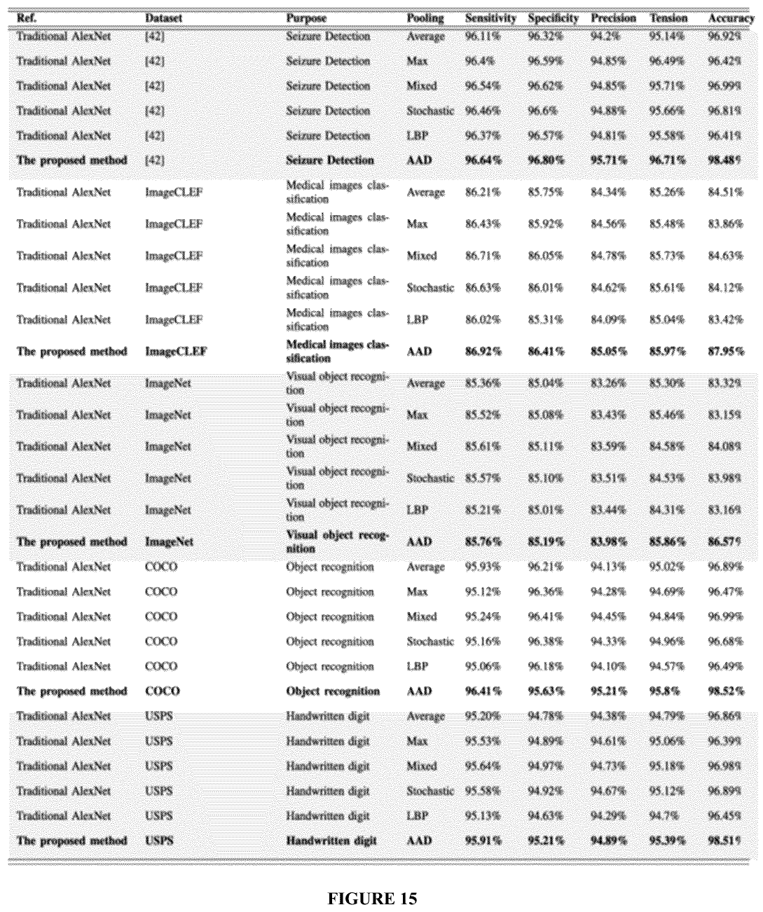

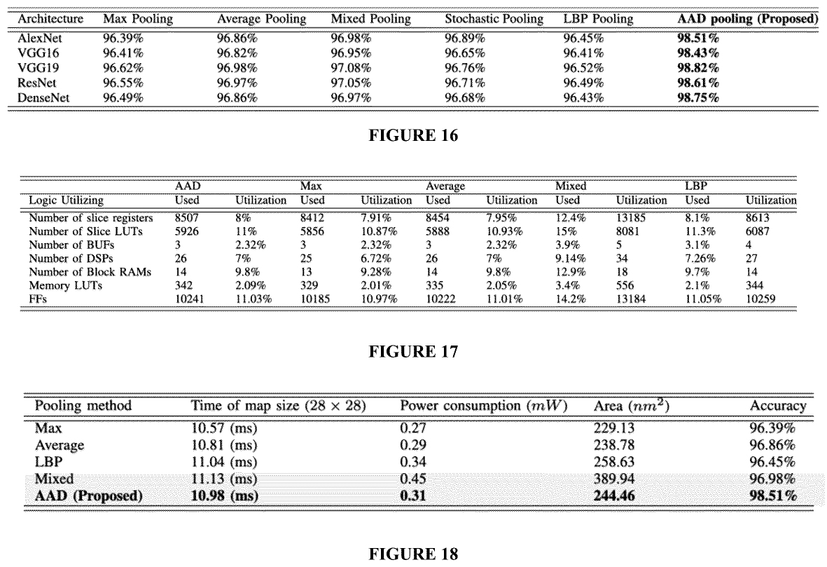

Testing Results. The AAD pooling is trained and tested on four different datasets. Cross validation is done while testing the proposed method to ensure robustness. For the evaluation, the complete CNN was implemented and evaluated by using TensorFlow by using the Evaluation Parameters prior described. AAD using horizontal deviation is compared with the AlexNet structure using average, mixed, stochastic, and LBP pooling, which is shown in FIG. 15. The results in FIG. 15 reflect the results from complete, integrated CNN implementation using different datasets and for different pooling methods. FIG. 15 also shows different evaluation parameters for each case. It can be seen that the CNN implementations using AAD pooling deliver higher performance than the other methods. For more validation of the proposed approach, in addition to AlexNet, AAD pooling was implemented in the following network architectures: VGG16, VGG19, ResNet, and DenseNet structures. The simulation results of these structures using AAD pooling and the USPS dataset are shown in FIG. 16. The simulation results show that AAD provides higher accuracy than the pooling methods in the literature that are being considered for pooling in a CNN accelerator. It is observed that AAD improves the learning accuracy and reduces training errors on different datasets and network structures. A varying number of pooling layers were also considered as the number of pooling layers impacts the results. The accuracy is 98.51%, 98.02%, and 97.32% for pooling layers of six, five, and four layers, respectively. In terms of the filter size, for 2×2 size, the accuracies of the AAD, max, average, and mixed are 98.51%, 96.39%, 96.86%, and 96.89%, respectively. For 3×3 filter size, the accuracies of AAD, max, average, and mixed pooling are 98.23%, 96.11%, 96.65%, and 96.63%, respectively. For 5×5 filter size, the accuracies of AAD, max, average, and mixed pooling are 98.05%, 95.98%, 96.51%, and 96.48%, respectively. Thus, the proposed method is beneficial for applications that need high accuracy.

To further study the proposed AAD pooling method, the performances are studied for different feature maps of sizes 14×14 and 28×28. For example, the execution time of the proposed AAD, max, and average pooling for feature size of 14×14 is 3.14, 2.37, and 2.91 ms, respectively. The results show that the AAD method incurs nearly the same time of computation, the max and average methods but higher accuracy. AAD has a lower computation time than the mixed pooling method. In addition, the results show that AAD is stable, robust, and suitable for hardware implementation. Using both vertical and horizontal deviations has an overhead on power and execution time. For example, it consumes 4% higher power than either the horizontal or vertical method alone, and its execution time is 3.29 ms for a 14×14 feature map. Thus, a method can be used depending on the requirement of the application. For power and speed economic implementation, the horizontal method is used.

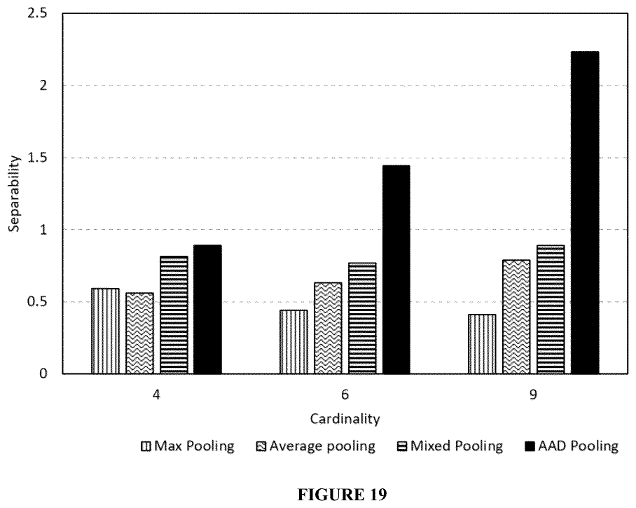

The proposed method is implemented in FPGA using VHDL and Altera Arria 10 GX FPGA 10AX115N2F45E1SG. The results are shown in FIG. 19 at α₁=0.3 and α₂=0.1 using AlexNet structure and the USPS dataset. The results show that the AAD method has higher separability than the other techniques signifying a higher ability to provide accurate data. The resource utilization results are shown in FIG. 17 in registers, look-up tables (LUTs), digital signal processings (DSPs), buffers, block RAM, and flip flops (FFs). FIG. 17 shows that the proposed method has a comparable resource consumption in comparison with the other methods. The method is tested using a pooling window of size (3×3) with a stride of two. Six modules are used in parallel for the AAD, max, average, and mixed methods. The AAD method is implemented using Synopsys® Design Compiler in 45-nm technology. It occupies an area of 244.46 nm2 and consumes 0.31-mW power using a global operating voltage source of 1.1 V. The power consumption is composed of internal and switching power. The internal power is dissipated within the boundary of a cell, while the switching power is dissipated due to the switching signal value. The internal power consumption is 0.23 mW (74%), and the switching power is 0.08 mW (26%). The leakage power consumption is 654.55 nW. The proposed method is compared with prior pooling methods in terms of execution time, power consumption, area, and accuracy using the USPS dataset, as shown in FIG. 18. The results show that the proposed method has a lower execution time, power consumption, and area than the mixed and LBP methods, but it has a small overhead compared to the max and average methods. The proposed method provides higher accuracy than the other pooling methods. All results show that the AAD pooling is suitable and beneficial for CNN accelerators to achieve very high accuracy.

The disclosed pooling method improves the accuracy in a CNN accelerator. The pooling layer is a crucial part of a CNN as it impacts the overall system's accuracy and speed. The AAD pooling achieves higher accuracy by considering each pixel's deviation to capture the most accurate pixel values during down-sampling. The AAD pooling achieved an accuracy of more than 98% without increasing computational complexity. In hardware, it was implemented using VHDL on Altera Arria 10 GX FPGA. It was also synthesized using Synopsys Design Compiler in 45-nm technology and found to occupy an area of 244.46 nm2 and consume 0.31 mW of power. The AAD pooling was also tested using the EEG, ImageNet, COCO, and USPS datasets and multiple neural network structures, including VGG16, VGG19, Resnet, and DenseNet, to ensure its validity and applicability for any structure. The extremely high accuracy, reasonable computational complexity, low cost in terms of area and power, and scalability of the proposed pooling make it suitable for several applications using a CNN accelerator in an IoT.

The foregoing description sets forth exemplary methods, parameters, and the like. It should be recognized, however, that such description is not intended as a limitation on the scope of the present disclosure but is instead provided as a description of exemplary embodiments.

In the foregoing description of the disclosure and embodiments, reference is made to the accompanying drawings in which are shown, by way of illustration, specific embodiments that can be practiced. It is to be understood that other embodiments and examples can be practiced, and changes can be made, without departing from the scope of the disclosure.

In addition, it is also to be understood that the singular forms “a,” “an,” and “the” used in the following description are intended to include the plural forms as well unless the context clearly indicates otherwise. It is also to be understood that the term “and/or” as used herein refers to and encompasses any and all possible combinations of one or more of the associated listed items. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Some portions of the detailed description that follow are presented in terms of algorithms and symbolic representations of operations on data bits within a computer memory. These algorithmic descriptions and representations are the means used by those skilled in the data processing arts to convey the substance of their work most effectively to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic, or optical signals capable of being stored, transferred, combined, compared, and otherwise manipulated. It is convenient at times, principally for reasons of common usage, to refer to these signals as bits, values, elements, symbols, characters, terms, numbers, or the like. Furthermore, it is also convenient at times to refer to certain arrangements of steps requiring physical manipulations of physical quantities as modules or code devices without loss of generality. It should be noted that the process steps and instructions of the present invention could be embodied in software, firmware, or hardware, and, when embodied in software, they could be downloaded to reside on, and be operated from, different platforms used by a variety of operating systems.

However, all of these and similar terms are to be associated with the appropriate physical quantities and are merely convenient labels applied to these quantities. Unless specifically stated otherwise as apparent from the following discussion, it is appreciated that, throughout the description, discussions utilizing terms such as “processing,” “computing,” “calculating,” “determining,” “displaying,” or the like refer to the action and processes of a computer system, or similar electronic computing device, that manipulates and transforms data represented as physical (electronic) quantities within the computer system memories or registers or other such information storage, transmission, or display devices.

The present invention also relates to a device for performing the operations herein. This device may be specially constructed for the required purpose or it may comprise a general-purpose computer selectively activated or reconfigured by a computer program stored in the computer. Such a computer program may be stored in a non-transitory, computer-readable storage medium such as, but not limited to, any type of disk, including floppy disks, optical disks, CD-ROMs, magnetic-optical disks, read-only memories (ROMs), random access memories (RAMs), EPROMs, EEPROMs, magnetic or optical cards, application-specific integrated circuits (ASICs), or any type of media suitable for storing electronic instructions and each coupled to a computer system bus. Furthermore, the computers referred to in the specification may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention, as described herein.

Although the description herein uses terms first, second, etc., to describe various elements, these elements should not be limited by the terms. These terms are only used to distinguish one element from another.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The above description is presented to enable a person skilled in the art to make and use the disclosure, and it is provided in the context of a particular application and its requirements. Various modifications to the preferred embodiments will be readily apparent to those skilled in the art, and the generic principles defined herein may be applied to other embodiments and applications without departing from the spirit and scope of the disclosure. Thus, this disclosure is not intended to be limited to the embodiments shown but is to be accorded the widest scope consistent with the principles and features disclosed herein. Finally, the entire disclosure of the patents and publications referred in this application are hereby incorporated herein by reference.

We claim:

1. An architecture for improving accuracy of the detection of features in input images in a convolutional neural network comprising:
a multi-layer perceptron classifier;
two or more convolutional layers; and
two or more pooling layers;
wherein the input image is fed into one convolutional layer, and an output of the convolutional layer is fed into a pooling layer;
wherein each pooling layer comprises at least one subtraction absolute block and at least one divider circuit;
wherein the input image is fed into a second convolutional layer, and an output of the second convolutional layer is fed into a second pooling layer; and
wherein a sequencing of convolutional layer to pooling layer is repeated through a fully connected layer;
wherein an output of the final pooling layer is connected to the multi-layer perceptron classifier; and
wherein an output of the multi-layer perceptron classifier comprises a result.

2. The architecture of claim 1, wherein each subtraction absolute block comprises:
at least two inputs;
an output;
a subtraction operator;
a comparator circuit;
a multiplication operator; and
a buffer;
wherein the inputs are connected to the subtraction operator;
wherein connections of an output of the subtraction operator comprises at least two routes, wherein:
one route is connected to the comparator circuit; and
one route is connected to the buffer; and
wherein the comparator circuit output and buffer output are connected to the multiplication operator.

3. The architecture of claim 1, wherein an additional input to the comparator circuit is a threshold value.

4. The architecture of claim 1, wherein:
the pooling layer comprises two or more subtraction absolute blocks;
the subtraction absolute blocks comprise functionality to operate in parallel;
the outputs of the subtraction absolute blocks are connected to a summation circuit; and
the summation circuit is connected to a divider circuit.

5. The architecture of claim 4, wherein an additional input to the divider circuit comprises an average deviation value.

6. The architecture of claim 4, wherein an output of the divider circuit comprises a value of non-pooled matrix values.

7. The architecture of claim 4, further comprising functionality to perform a sliding window algorithm.

8. The architecture of claim 4, further comprising functionality to perform a sliding window algorithm, wherein a stride length is determined by a pooling size.

9. A method for performing absolute average deviation pooling in a convolutional neural network, comprising:
(a) utilizing a convolutional neural network comprising one or more convolutional layers;
(b) inserting a pooling layer between each convolutional layer in the convolutional neural network;
(c) configuring each pooling layer to perform absolute average deviation pooling, wherein each pooling layer comprises one or more subtraction absolute blocks, and wherein each subtraction absolute block comprises two inputs;
(d) obtaining an absolute deviation from the subtraction absolute block; and
(e) dividing the absolute deviation by 2.

10. The method of claim 9, wherein the subtraction absolute block further comprises:
(a) a subtraction operator;
(b) a comparator circuit;
(c) a multiplication operator; and
(d) a buffer.

11. The method of claim 9, further comprising:
(a) applying a subtraction operation to the two inputs to obtain an output, and wherein the output is connected to two routes, wherein one route is connected to a buffer and the other route is connected to a comparator circuit;
(b) buffering the output by the buffer;
(c) comparing the output to a threshold value by the comparator circuit, wherein:
a. if comparison by the comparator circuit produces a positive result, the comparator circuit provides a positive 1 as its output;
b. if comparison by the comparator circuit produces a negative result, the comparator circuit produces a negative 1 as its output;
(e) multiplying the comparator circuit output with the buffer output to obtain an ab solute deviation.

12. The method of claim 9, wherein the pooling layer comprises two or more subtraction absolute blocks, further comprising:
(a) operating the subtraction absolute blocks in parallel;
(b) obtaining an output of each subtraction absolute block; and
(c) adding together all outputs of the subtraction absolute block by the summation circuit.

13. The method of claim 9, further comprising applying a sliding window algorithm.
